(19) United States
(12) Patent Application Publication
(10) Pub. No.: US 2025/0187826 A1
(43) Pub. Date: Jun. 12, 2025

(54) A REMOTELY OPERATED VEHICLE, AN AUTOMATED STORAGE AND RETRIEVAL SYSTEM AND A METHOD OF OPERATING A REMOTELY OPERATED VEHICLE FOR HANDLING A GOODS HOLDER OF AN AUTOMATED STORAGE AND RETRIEVAL SYSTEM

(71) Applicant: AutoStore Technology AS, Nedre Vats (NO)

(72) Inventors: Trond Austrheim, Etne (NO); Ivar Fjeldheim, Haugesund (NO)

(21) Appl. No.: 18/844,350

(22) PCT Filed: Feb. 17, 2023
(86) PCT No.: PCT/EP2023/054068

§ 371 Date: Sep. 5, 2024

(30) Foreign Application Priority Data
Mar. 8, 2022 (NO) 20220291

(51) Int. Cl. B65G 1/04; B61C 9/48; B61C 13/04; B61F 5/50

(52) U.S. Cl. CPC B65G 1/0464; B61C 13/04; B61F 5/50; B61C 9/48

(57) ABSTRACT

The invention relates to a remotely operated vehicle (50) for handling a goods holder (106) on a two-dimensional rail system (108) of an automated storage and retrieval system (1). The vehicle (50) comprises a first wheel mount (12) which is vertically displaceable relative to a frame (14) of the vehicle body, the first wheel mount (12) carrying a first pair (61) of coplanar wheels of said first set of wheels (6), and a second wheel mount (13) which is vertically displaceable relative to the frame (14) of the vehicle body, the second wheel mount (13) carrying a second pair (62) of coplanar wheels of said first set of wheels (6), the second wheel mount (13) being arranged parallel to and on an opposite side of said cavity (22) to said first wheel mount (12). A mechanism (15) for vertically displacing the first wheel mount (12) relative to the frame (14) of the vehicle body (10) is movable between a first position and a second position such that the movement of the mechanism (15) from the first to the second position results in the first wheel mount (12) being displaced vertically relative to the frame (14) of the vehicle body. A coupling assembly (19) couples the first (12) and the second (13) wheel mounts so that vertical movement of the first wheel mount (12) is transferred to the second wheel mount (13). The invention further relates to an automated storage and retrieval system (1) comprising said remotely operated vehicle (50) and a method of operating said remotely operated vehicle (50).

The present invention relates primarily to a remotely operated vehicle for handling a goods holder of an automated storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time. In the art, lifting and lowering of the set of wheels, in order to change direction of movement of the container handling vehicle 201, 301, 401 from X-direction to Y-direction or vice versa, is known as “trackshift”. Details of a trackshift mechanism are disclosed in WO2019/137866A1.

The trackshift mechanism of WO2019/137866A1 comprises a motor for providing rotational drive, a drive crank coupled to the motor to transmit rotational drive from the motor, a coupler link pivotally coupled to the drive crank, a lift rocker pivotally coupled to the coupler link, said coupler link for coupling rotational drive from the drive crank to the lift rocker and a displacement link pivotally coupled to the lift rocker. Said motor is provided above a cavity for receiving a storage container. A displacement plate is pivotally coupled to the displacement link such that the lift rocker, the displacement link, and the displacement plate act as a rocker slider mechanism that raises and lowers the displacement plate and the thereto fixedly connected wheels. Drive motors for movement in X/Y-direction are provided behind the displacement plate, near drivable wheels.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling 25 vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the 30 original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

As is well-known in the art, system errors attributable to the above-defined “track-shift” procedure are among the most critical system errors in relation to cost, stops and downtime. An example of such, track-shift related error is “Track-shift at stop”—a still container handling vehicle attempting to change its direction of movement being unable to properly raise/lower and/or position a set of wheels.

On this background, there is a continuous strive to improve container handling vehicles in order to reduce occurrence of track-shift-related errors.

### SUMMARY OF THE INVENTION

The present invention is set forth and characterized in the independent claims, while the dependent claims describe other characteristics of the invention.

The invention relates to a remotely operated vehicle for handling a goods holder on a two-dimensional rail system of an automated storage and retrieval system, wherein said vehicle comprises a vehicle body defining a cavity for storing the goods holder, a first set of wheels enabling movement of the remotely operated vehicle in a first horizontal direction of the rail system and a second set of wheels enabling movement of the remotely operated vehicle in a second horizontal direction of the rail system, said second horizontal direction being perpendicular to the first horizontal direction, wherein said vehicle comprises:
a first wheel mount which is vertically displaceable relative to a frame of the vehicle body, the first wheel mount carrying a first pair of coplanar wheels of said first set of wheels,
a second wheel mount which is vertically displaceable relative to the frame of the vehicle body, the second wheel mount carrying a second pair of coplanar wheels of said first set of wheels, the second wheel mount being arranged parallel to and on an opposite side of said cavity to said first wheel mount,
a mechanism for vertically displacing the first wheel mount relative to the frame of the vehicle body, said mechanism being movable between a first position and a second position such that the movement of the mechanism from the first to the second position results in the first wheel mount being displaced vertically relative to the frame of the vehicle body,
a coupling assembly coupling the first and the second wheel mounts so that vertical movement of the first wheel mount is transferred to the second wheel mount, and
a motor section in which a track-shift motor that drives said mechanism and a drive motor for propelling said vehicle in X-direction are provided.

By providing the remotely operated vehicle as defined above a number of advantages is achieved.

More specifically, it becomes possible to more purposely match design of the wheel mounts with the general design and properties of thereto associated pair of coplanar wheels. For instance, when the wheel set comprises a pair of drive wheels as well as a pair of passive wheels, the wheel weight to be vertically displaced differs greatly—the drive wheels and thereto associated components weigh significantly more than the corresponding passive wheels. An optimal vehicle design taking this into account provides two structurally different wheel mounts, each tailored for the respective coplanar wheel pair. As a result, component wear may be reduced and useful life of the wheels and wheel mounts may be extended. The coupling assembly coupling the first and the second wheel mounts ensures that vertical movement is transferred from the first wheel mount to the second wheel mount while track-shift procedure is being performed.

A further advantage achieved is greater liberty when it comes to designing wheel displacement solutions in general and wheel mounts in particular. More specifically, design considerations regarding size and shape of the first wheel mount are substantially separated from design considerations involving the second wheel mount. This is particularly useful in the vehicle design phase, space being scarce in a remotely operated vehicle, especially on the vehicle side being adjacent the cavity for storing goods holder.

In the related context, it also becomes possible to design a more robust vertical displacement solution, less likely to generate track-shift-related errors.

More specifically, by providing a motor section in which a track-shift motor and a drive motor for propelling the vehicle in X-direction are provided, heavy motor components may be grouped, i.e. confined in a limited space, onboard the vehicle. Hereby, a simplified vehicle powertrain (here also encompassing the track-shift mechanism) may be obtained. For instance, it becomes possible to provide a pair of simple passive wheels on the distal side of the vehicle (the side completely devoid of heavy components) and a pair of drive wheels on the proximal vehicle side (the side associated with the motor section housing heavy motor components).

Second aspect of the invention relates to a method of operating a remotely operated vehicle for handling a goods holder on a two-dimensional rail system of an automated storage and retrieval system in accordance with claim 20.

For the sake of brevity, advantages discussed above in connection with the remotely operated vehicle may even be associated with the corresponding method and are not further discussed.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system. Analogously, the term “storage container” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle/remotely operated vehicle having a centrally arranged cavity for carrying storage containers therein.

FIG. 3a is a perspective view of a prior art container handling vehicle/remotely operated vehicle having a cantilever for carrying storage containers underneath.

FIG. 3b is a perspective view, seen from below, of a prior art container handling vehicle/remotely operated vehicle having an internally arranged cavity for carrying storage containers therein.

FIG. 4a is a side view of a rear side of a remotely operated vehicle showing a mechanism for vertically displacing a first wheel mount relative to a frame of a vehicle body in accordance with one embodiment of the present invention.

FIG. 4b is a close-up of the first wheel mount in accordance with an embodiment of the present invention.

FIG. 5 is a side view of a front side of a remotely operated vehicle showing an assembly for vertically displacing a second wheel bracket and the second wheel bracket in accordance with one embodiment of the present invention.

FIG. 6 is a side view of a front side of a remotely operated vehicle showing an assembly for vertically displacing a second wheel bracket and the second wheel bracket in accordance with another embodiment of the present invention.

FIG. 7 contextualizes another aspect of the present invention by showing two different scenarios where remotely operated vehicles are positioned on the rails of the framework structure.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

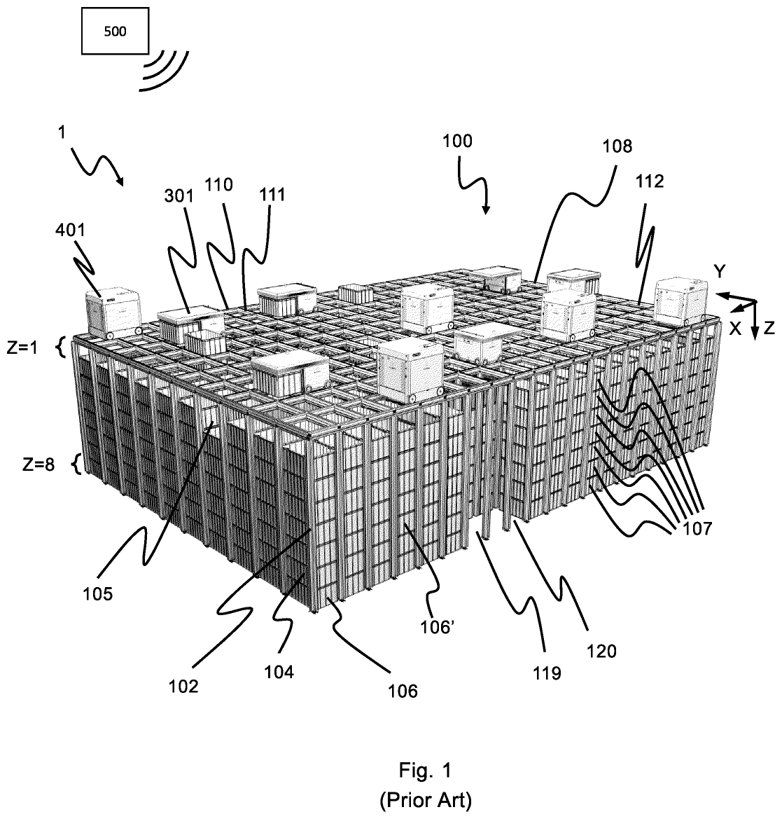

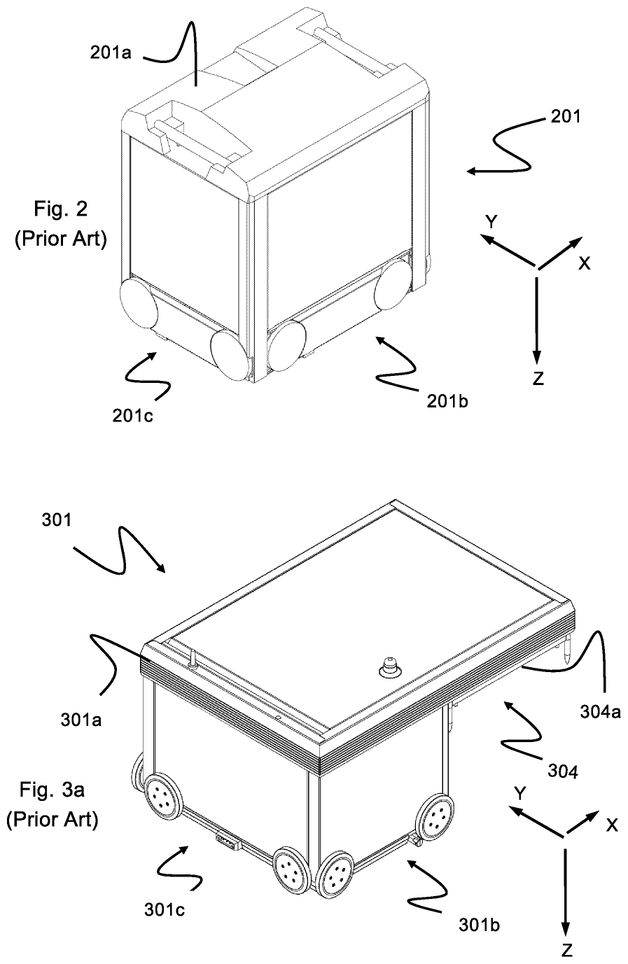

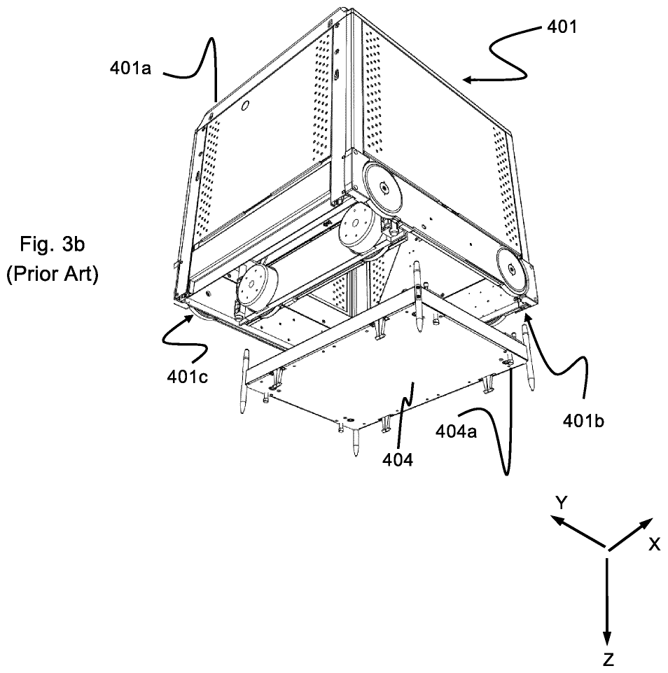

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

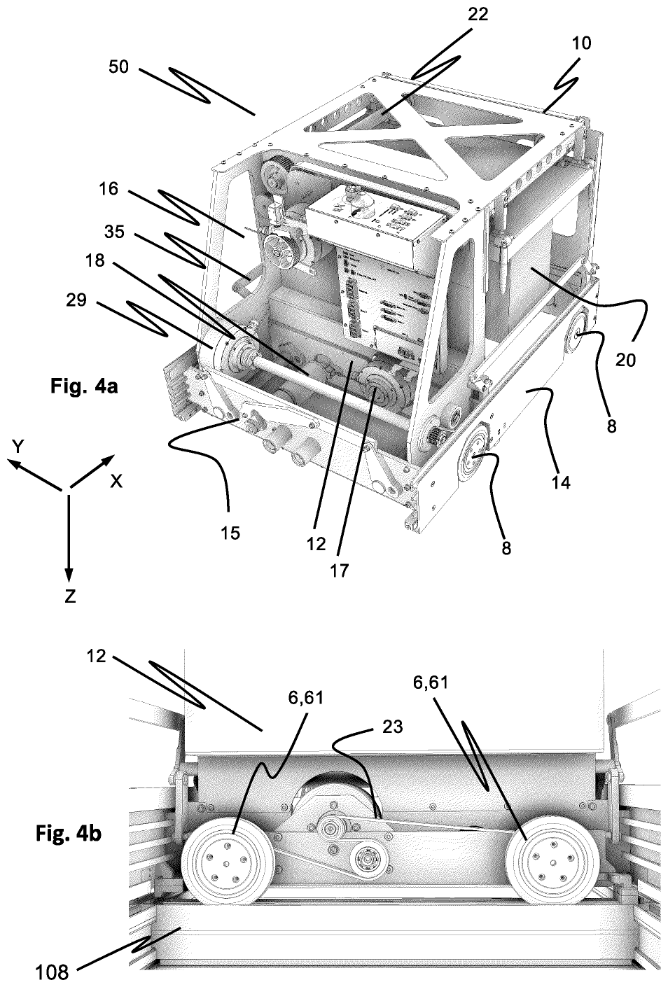

Various aspects of the present invention will now be discussed in more detail with reference to FIGS. 4-7.

FIG. 4a is a perspective side view of a rear side of a remotely operated vehicle showing a mechanism for vertically displacing a first wheel mount relative to a frame of a vehicle body in accordance with one embodiment of the present invention.

The remotely operated vehicle 50 is for handling a goods holder on a two-dimensional rail system of an automated storage and retrieval system shown in FIG. 1. The vehicle 50 comprises a vehicle body 10 defining a cavity 22 for storing the goods holder. The vehicle body 10 is a super-structure attached to a frame 14, i.e. chassis, of the remotely operated vehicle 50.

The vehicle 50 further comprises a first set of wheels (not visible in FIG. 4a; two wheels of the set are shown in FIG. 4b) enabling movement of the remotely operated vehicle 50 in a first (Y) horizontal direction of the rail system and a second set of wheels (8; two of these wheels are visible in FIG. 4a) enabling movement of the remotely operated vehicle 50 in a second (X) horizontal direction of the rail system, said second horizontal (X) direction being, as seen in FIG. 1, perpendicular to the first (Y) horizontal direction.

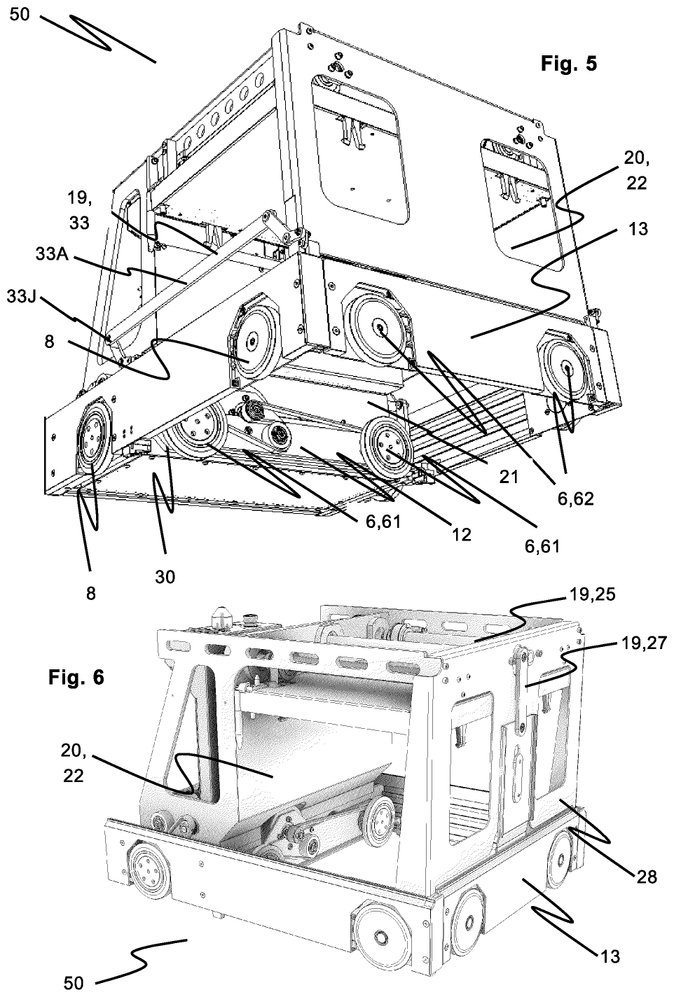

The vehicle 50 also comprises a first wheel mount 12 which is vertically displaceable relative to a frame 14 of the vehicle body. The first wheel mount 12 carries a first pair 61 of coplanar wheels of said first set of wheels. A close-up of the first wheel mount 12 is shown in FIG. 4b. A toothed belt 23 of FIG. 4b transfers motor power to the first pair 61 of coplanar wheels. A drive motor 17 for these wheels (Y-direction) is shown in FIG. 4a. Still with reference to FIG. 4b, the first wheel mount 12 is in its lowered state, i.e. in engagement with the rail 108. The second, oppositely arranged, wheel mount (not shown in FIG. 4b) is also in the lowered state and the vehicle may travel along that rail 108 in Y-direction. In case the vehicle 50 needs to change its direction of movement, a track-shift procedure needs to be performed. A track-shift motor 18 of FIG. 4a provides power necessary to lift/lower the wheels. Accordingly, the wheel mounts 12, 13 are raised so that the second set of wheels 8 (shown in FIG. 5) that is fixed relative to the frame becomes engaged with the rail 108. Subsequently, the vehicle may travel along that rail 108 in X-direction (powered by a motor 29 of FIG. 4a).

Turning back to FIG. 4a, a mechanism 15 for vertically displacing the first wheel mount 12 relative to the frame 14 of the vehicle body is shown. The mechanism 15 is movable between a first position and a second position such that the movement of the mechanism 15 from the first to the second position results in the first wheel mount 12 being displaced vertically relative to the frame 14 of the vehicle body.

The mechanism 15 for vertically displacing the first wheel mount 12 relative to the frame 14 of the vehicle body is provided in a motor section 16 of the remotely operated vehicle 50. Moreover, said mechanism 15 is driven by the track-shift motor 18 provided in the motor section 16. More specifically, the mechanism 15 is arranged opposite said first wheel mount of FIG. 4b. The mechanism 15 is arranged outside a wheel base 21 (shown in FIG. 5) defined by the wheels associated with the first and the second wheel mounts. Motor section 16 further holds the previously-mentioned drive motor 29 for propelling the vehicle 50 in the X-direction.

By providing the motor section in which a track-shift motor and a drive motor for propelling the vehicle in X-direction are provided, heavy motor components may be grouped, i.e. confined in a limited space, onboard the vehicle. Hereby, a simplified vehicle powertrain (here also encompassing the track-shift mechanism) may be obtained. For instance, it becomes possible to provide a pair of simple passive wheels on the distal side of the vehicle (the side completely devoid of heavy components) and a pair of drive wheels on the proximal vehicle side (the side associated with the motor section housing heavy motor components).

FIG. 5 is a perspective side view of a front side of a remotely operated vehicle 50 showing a coupling assembly 19 for vertically displacing a second 13 wheel bracket and the second wheel bracket 13 itself in accordance with one embodiment of the present invention. The shown vehicle body 10 has an asymmetric shape with respect to a plane extending in YZ-direction (identified in FIG. 4a).

In addition to the previously discussed first wheel mount 12 and a first pair of wheels 61, a second wheel mount 13 which also is vertically displaceable relative to the frame 14 of the vehicle body 10, the second wheel mount 13 carrying a second pair 62 of coplanar wheels of said first set of wheels 6, is shown. The second wheel mount 13 is arranged parallel to said first wheel mount 12 and on an opposite side of a cavity 22. A coupling assembly 19 couples the first 12 and the second 13 wheel mounts so that vertical movement of the first wheel mount 12 is transferred to the second wheel mount 13. Center of gravity (not shown) of the remotely operated vehicle 50 is positioned in the cavity section 20 comprising the cavity 22.

Still with reference to FIG. 5, one pair 61 of the first set of wheels 6 is a pair of coplanar driven wheels supported by the first wheel mount 12, said mount being mounted to a structural crosspiece 30 of the vehicle body 10. Second pair 62 of the first set of wheels 6 is a pair of coplanar passive wheels. All wheels 61, 62 of the first set of wheels 6 are arranged to be vertically displaced in unison. All four wheels of the second set of wheels 8 are fixed relative to the frame 14 of the vehicle 50.

The coupling assembly 19 comprises a first link arm 33 and a second link arm (35; visible in FIG. 4a) arranged on opposite sides of the cavity 22. In one embodiment, the first 33 and the second 35 link arms are identical. Each of the first 33 and the second link arms 35 couples the first 12 and the second 13 wheel mounts. Each link arm comprises arm parts 33A connected by means of arm joints 33J so that all arm parts 33A may rotate and/or translate in the same plane. Each link arm 33, 35 extends in a direction perpendicular to planes of the first 61 and the second 62 pair of coplanar wheels. A wheel base 21 discussed in conjunction with FIG. 4a is also shown in FIG. 5.

Still with reference to the vehicle 50 shown in FIG. 5, it hereby becomes possible to more purposely match design of the wheel mounts 12, 13 with the general design and properties of thereto associated pair of coplanar wheels 61, 62. For instance, when the wheel set 6 comprises a pair of drive wheels 61 as well as a pair of passive wheels 62, the wheel weight to be vertically displaced differs greatly—the drive wheels 61 and thereto associated components weigh significantly more than the corresponding passive wheels 62. An optimal vehicle design taking this into account provides two structurally different wheel mounts, each tailored for the respective coplanar wheel pair. As a result, component wear may be reduced and useful life of the wheels and wheel mounts may be extended. The coupling assembly 19 coupling the first and the second wheel mounts ensures that vertical movement is transferred from the first wheel mount to the second wheel mount while track-shift procedure is being performed.

A further advantage achieved is greater liberty when it comes to designing wheel displacement solutions in general and wheel mounts 12, 13 in particular. More specifically, design considerations regarding size and shape of the first wheel mount 12 are substantially separated from design considerations involving the second wheel mount 13. This is particularly useful in the vehicle design phase, space being scarce in a remotely operated vehicle, especially on the vehicle side being adjacent the cavity 22 for storing goods holder. In the related context, it also becomes possible to design a more robust vertical displacement solution, less likely to generate track-shift-related errors.

FIG. 6 is a side view of a front side of a remotely operated vehicle 50 showing a coupling assembly 19 for vertically displacing a second wheel bracket 13 and the second wheel bracket in accordance with another embodiment of the present invention.

A cavity 22 for storing the goods holder is part of a cavity section 20 of the vehicle, said cavity section 22 being provided adjacent an external front wall 28 forming part of a periphery of the remotely operated vehicle 50. In the shown embodiment, the second wheel mount 13 forms part of the external front wall 28 of the vehicle body and the external front wall 28 is flat and perpendicular to a horizontal plane. In this embodiment, the coupling assembly 19 comprises a horizontally extending bar 25 that is vertically displaceable, said bar 25 being provided above the cavity 22. The vertically displaceable bar 25 and the first 12 and the second 13 wheel mount are coupled by at least one vertically extending coupler link 27 that is vertically displaceable. For the sake of brevity, other parts of FIG. 6, discussed in connection with FIG. 5, are not further discussed.

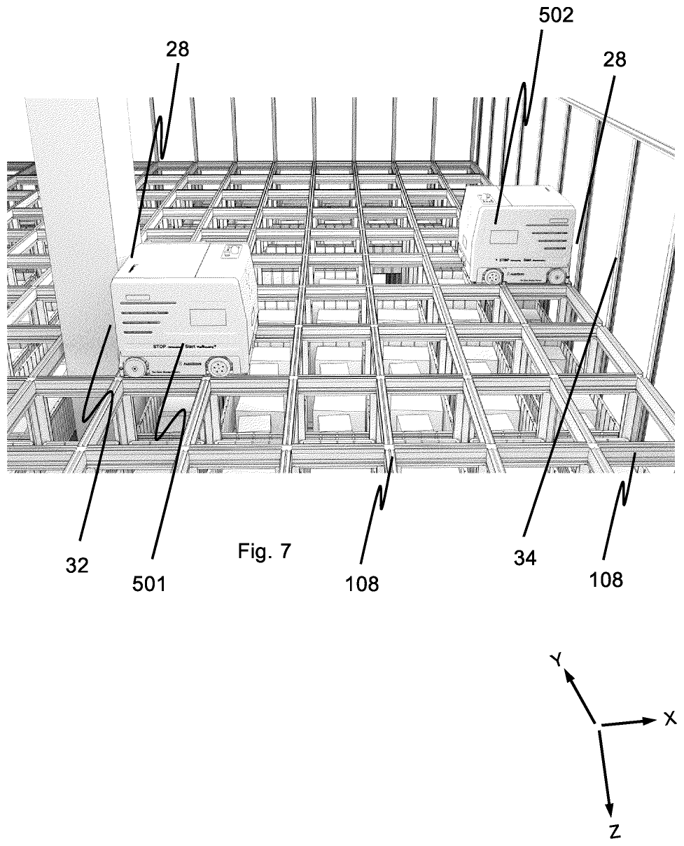

FIG. 7 contextualizes another aspect of the present invention by showing two different scenarios where remotely operated vehicles are positioned on the rails 108 of the framework structure.

A first one of the remotely operated vehicles 501 shown in FIG. 7 is positioned on the storage grid discussed in conjunction with FIG. 1 and above a storage column being immediately adjacent a roof supporting column 32. By virtue of its design, the vehicle 501 is able to access goods holders stored in said storage column. More specifically, the cavity section of the vehicle 501 includes a peripheral external wall 28 facing the roof supporting column 32. The external wall 28 is flat and perpendicular to a horizontal (XY) plane. When the flat, external wall 28 of the vehicle 501 is very close to or even abutting the roof supporting column 32, the cavity section is aligned with the storage column below such that the goods holder may be vertically extracted by the remotely operated vehicle 501. Once the goods holder is extracted, the vehicle 501 may, if required, perform a track-shift procedure as discussed in connection with FIGS. 4a-4b so that the vehicle 501 changes its direction of movement.

The other one of the remotely operated vehicles 502 shown in FIG. 7 is shown positioned at the periphery of grid structure, adjacent to a protective fence 34 delimiting the grid structure. Analogously to what has been discussed in connection with the first remotely operated vehicle 501 of FIG. 7, the external wall 28 of the vehicle 502 being flat and perpendicular to a horizontal (XY) plane entails above-discussed benefits, such as improved capability to retrieve goods holders that are difficult to access.

A common feature of the two scenarios of FIG. 7 is the remotely operated vehicle 501, 502, when lifting goods holders from a storage column or lowering goods holders into the storage column, covering a single storage column across in one horizontal direction of the rail system 108 and covering between one and two storage columns across in another horizontal direction of the rail system 108. For a given grid size, this relatively small vehicle footprint opens for usage of larger number of remotely operated vehicles than what was previously feasible. More specifically, in one of the horizontal directions it is possible for two operating vehicles 501, 502 to occupy adjacent grid positions so that the flat, external wall 28 of one vehicle 501, 502 faces the flat, external wall 28 of another vehicle 501, 502.

In the preceding description, various aspects of the remotely operated vehicle for a storage and retrieval system for storing goods holders according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Storage and retrieval system
6 First set of wheels
8 Second set of wheels
10 Vehicle body
12 First wheel mount
13 Second wheel mount
14 Frame of the vehicle body
15 Mechanism for vertically displacing the first wheel mount
16 Motor section
17 Drive motor (Y-direction)
18 Track-shift motor
19 Coupling assembly
20 Cavity section
21 Wheel base
22 Cavity
23 Toothed belt
25 Horizontally extending bar
27 Coupler link
28 External wall
29 Drive motor (X-direction)
30 Crosspiece
32 Roof-supporting column
33 First link arm
33A Arm parts
33J Arm joints
34 Protective fence
35 Second link arm
50 Remotely operated vehicle
61 First pair of coplanar wheels of the first set of wheels
62 Second pair of coplanar wheels of the first set of wheels
100 Framework structure
102 Upright members of framework structure
104 Storage grid
105 Storage column
106 Storage container/goods holder
106′ Particular position of storage container
ωStack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
501 First remotely operated vehicle
502 Second remotely operated vehicle
X First direction
Y Second direction
Z Third direction

1. A remotely operated vehicle for handling a goods holder on a two-dimensional rail system of an automated storage and retrieval system, wherein said vehicle comprises a vehicle body defining a cavity for storing the goods holder, a first set of wheels enabling movement of the remotely operated vehicle in a first horizontal direction of the rail system and a second set of wheels enabling the movement of the remotely operated vehicle in a second horizontal direction of the rail system, said second horizontal direction being perpendicular to the first horizontal direction, wherein said vehicle comprises:
a first wheel mount which is vertically displaceable relative to a frame of the vehicle body, the first wheel mount carrying a first pair of coplanar wheels of said first set of wheels;
a second wheel mount which is vertically displaceable relative to the frame of the vehicle body, the second wheel mount carrying a second pair of coplanar wheels of said first set of wheels, the second wheel mount being arranged parallel to and on an opposite side of said cavity to said first wheel mount;
a mechanism for vertically displacing the first wheel mount relative to the frame of the vehicle body, said mechanism being movable between a first position and a second position such that the movement of the mechanism from the first to the second position results in the first wheel mount being displaced vertically relative to the frame of the vehicle body;
a coupling assembly coupling the first and the second wheel mounts so that vertical movement of the first wheel mount is transferred to the second wheel mount; and
a motor section in which a track-shift motor that drives said mechanism and a drive motor for propelling said vehicle in X-direction are provided.

2. The remotely operated vehicle of claim 1, wherein the mechanism for vertically displacing the first wheel mount relative to the frame of the vehicle body is provided in a motor section of the remotely operated vehicle.

3. The remotely operated vehicle of claim 1, wherein the mechanism for vertically displacing the first wheel mount relative to the frame of the vehicle body is driven by a motor provided in the motor section of the remotely operated vehicle.

4. The remotely operated vehicle of claim 1, wherein the mechanism for vertically displacing the first wheel mount relative to the frame of the vehicle body is arranged opposite said first wheel mount.

5. The remotely operated vehicle of claim 1, wherein the mechanism for vertically displacing the first wheel mount relative to the frame of the vehicle body is arranged outside a wheel base defined by the wheels of the first and the second wheel mounts.

6. The remotely operated vehicle of claim 1, wherein the cavity for storing the goods holder is part of a cavity section of the vehicle, said cavity section being provided adjacent an external front wall forming part of a periphery of the remotely operated vehicle.

7. The remotely operated vehicle of claim 6, wherein the second wheel mount forms part of the external front wall of the vehicle body.

8. The remotely operated vehicle of claim 6, wherein said external front wall is flat and perpendicular to a horizontal plane.

9. The remotely operated vehicle of claim 1, wherein one pair of the first set of wheels is a pair of coplanar passive wheels.

10. The remotely operated vehicle of claim 1, wherein one pair of the first set of wheels is a pair of coplanar driven wheels supported by the first wheel mount, said mount being mounted to a structural crosspiece of the vehicle body.

11. The remotely operated vehicle of claim 1, wherein all wheels of the first set of wheels are arranged to be vertically displaced in unison.

12. The remotely operated vehicle of claim 1, wherein all wheels of the second set of wheels are fixed relative to the frame of the vehicle.

13. The remotely operated vehicle of claim 1, wherein said coupling assembly comprises a horizontally extending bar that is vertically displaceable, said bar being provided above said cavity.

14. The remotely operated vehicle of claim 13, wherein the vertically displaceable bar and the first and/or the second wheel mount are coupled by at least one vertically extending coupler link that is vertically displaceable.

15. The remotely operated vehicle claim 1, wherein said coupling assembly comprises a first link arm and a second link arm arranged on opposite sides of the cavity.

16. The remotely operated vehicle of claim 15, wherein each of the first and the second link arms couples the first and the second wheel mounts.

17. The remotely operated vehicle claim 15, wherein the first and the second link arms are identical.

18. The remotely operated vehicle claim 15, wherein each link arm comprises arm parts connected by means of joints so that all arm parts may rotate and/or translate in the same a single plane.

19. An automated storage and retrieval system comprising a remotely operated vehicle claim 1, said system comprising a plurality of storage columns and a rail system provided above the plurality of storage columns, wherein the goods holder may be lowered into or lifted from any of the storage columns by the remotely operated vehicle operating on the rail system.

20. A method of operating a remotely operated vehicle for handling a goods holder on a two-dimensional rail system of an automated storage and retrieval system, wherein said vehicle comprises a vehicle body, a cavity for receiving the goods holder and a first set of wheels enabling movement of the remotely operated vehicle in a first horizontal direction of the rail system and a second set of wheels enabling the movement of the remotely operated vehicle in a second horizontal direction of the rail system, said second direction being perpendicular to the first direction, wherein said vehicle comprises a first wheel mount vertically displaceable relative to a frame of the vehicle body, the first wheel mount carrying a first pair of coplanar wheels of said first set of wheels, a second wheel mount vertically displaceable relative to the frame of the vehicle body, the second wheel mount carrying a second pair of coplanar wheels of said first set of wheels, the second wheel mount being arranged parallel and on an opposite side of the cavity to said first wheel mount, a mechanism coupled to the first wheel mount and for vertically displacing the first wheel mount relative to the frame of the vehicle body and an assembly coupling the first and the second wheel mounts, said method comprising:
providing a track-shift motor that drives said mechanism and a drive motor for propelling said vehicle in X-direction in a motor section of the remotely operated vehicle; and
moving said mechanism coupled to the first wheel mount between a first position and a second position such that the first wheel mount and thereto associated pair of coplanar wheels and the second wheel mount and thereto associated pair of coplanar wheels are vertically displaced relative to the frame of the vehicle body.
